(19) United States
(12) Patent Application Publication
(10) Pub. No.: US 2021/0209566 A1
(43) Pub. Date: Jul. 8, 2021

(54) SYSTEMS AND METHODS FOR USING ALTERNATE PAYMENT METHODS INSIDE A VEHICLE

(71) Applicant: Wells Fargo Bank, N.A., San Francisco, CA (US)

(72) Inventors: Rameshchandra B. Ketharaju, Telengana (IN); Ramanathan Ramanathan, Bellevue, WA (US)

(21) Appl. No.: 15/289,644

(22) Filed: Oct. 10, 2016

Related U.S. Application Data
(60) Provisional application No. 62/240,195, filed on Oct. 12, 2015.

(51) Int. Cl. G06Q 20/10; G06Q 20/34; G06Q 20/40; G06Q 20/36; H04W 4/00

(52) U.S. Cl. CPC G06Q 20/102; G06Q 20/351; G06Q 50/30; G06Q 20/36; H04W 4/008; G06Q 20/40145

(57) ABSTRACT

A vehicle payment device (VPD) is described along with a financial institution computing system. The VPD allows for secure communication with a merchant terminal. The communication may be through NFC or other wireless technology. The VPD contains financial information that allows for payment of goods or services. In an alternative arrangement, the VPD allows for the financial information to be temporarily overridden or changed in the event of a new driver or user of the vehicle. The temporary financial information is then used for the payment of goods or services related to the vehicle. In another alternative arrangement, financial information is combined to allow the sharing of costs for payment of goods or services. The VPD may automatically detect the presence of alternate sources of financial information. Examples of alternate sources of financial information include mobile wallets on cellular phones or other mobile devices.

### CROSS-REFERENCE TO RELATED APPLICATIONS

This application claims priority to U.S. Provisional Patent Application No. 62/240,195, entitled “SYSTEMS AND METHODS FOR USING ALTERNATE PAYMENT METHODS INSIDE A VEHICLE,” by Ketharaju et al., filed on Oct. 12, 2015, which is herein incorporated by reference in its entirety and for all purposes.

### BACKGROUND

Vehicle owners and operators routinely pay for goods and services associated with usage of the vehicle, such as fuel, tolls, food and the like. Vehicle owners may use a credit card or other payment method in order to facilitate payments for goods and services related to vehicle use. Some systems allow for payment methods to be linked to specific vehicles. For example, a driver can place a toll transponder on or in his or her vehicle such that when the vehicle passes through an automated tool booth, the toll booth scans the toll transponder (e.g., via RFID communication) and bills the payment method associated with the toll transponder (e.g., a credit card).

Methods of payment, such as toll road devices do not allow for payment by someone borrowing a vehicle or shared payments between drivers and passengers of a vehicle. There is no current way for an individual who is not the vehicle owner or the authorized payer of the already linked payment method to override the default payment associated with the vehicle and pay.

### SUMMARY

One embodiment relates to a method of facilitating a payment to a merchant via a payment device associated with a vehicle. The method includes a vehicle payment device (VPD) receiving, by a processor of the payment device, an indication of a presence of an occupant in the vehicle, receiving, by the processor, a payment request from a merchant payment terminal, selecting, by the processor, a payment method based at least in part on the presence of the occupant in the vehicle, and transmitting, by the processor, payment information relating to the payment method to the merchant payment terminal. Examples of merchants may include toll stations, gas stations, drive-thru lanes in restaurants, and pay parking lots. Alternately, the VPD may use a combination or sub-combination of default financial information and new financial information to create a one-time use virtual credit card number to provide to the merchant for payment for goods or services. This virtual (one-time use or temporary) credit card number may be generated by communicating over a network to a financial institution computing system. The network may be a cellular network (3G, 4G, 5G, etc.).

Another embodiment may be a financial institution computing system associated with a financial institution. The system may comprise a network interface configured to communicate with a customer payment device and a merchant point of sale terminal associated with a merchant via a network, an account database storing information relating to a plurality of financial accounts maintained by the financial institution, an VPD database storing information relating to identifying vehicle payment devices, a memory, and at least one processor. The processor may be configured to receive, from the customer device via the network, a transaction request, the transaction request including information related to two or more of the plurality of financial accounts, generate a virtual payment number linked to the two or more of the plurality of financial accounts, transmit to the customer device via the network, the virtual payment number, store the virtual payment number, and receive from the merchant point of sale terminal a payment request including the virtual payment number. The credit card number may be used to pay for goods and services provided by the merchant by the merchant communicating with a financial institution computing system over a network. The merchant calculates the costs of goods and/or services provided and sends a financial payment request to a financial institution computing system. The vehicle payment device may be integrated into a vehicle. The secure communications channel may be NFC communication or other short-range wireless technology.

A further embodiment relates to a system for sharing payments of costs associated with driving a vehicle. The system may comprise a network interface configured to communicate with a merchant point of sale terminal associated with a merchant and a financial institution computing system associated with a financial institution, a memory storing default payment information, a display capable of communication to a user, and at least one processor. The processor may be configured to receive new payment information and store the payment information in the computer memory, share the costs associated with the merchant between the default payment information and the new payment information, transmit financial information to the merchant to facilitate payment; and communicate over the network interface to the financial institution computing system.

A further embodiment relates to a non-transitory computer-readable media having computer-executable instructions embodied therein that, when executed by a processor of a vehicle payment device, cause the vehicle payment device to perform a process. The process includes receiving, by the processor of the payment device, an indication of a presence of an occupant in the vehicle, receiving, by the processor, a payment request from a merchant payment terminal, selecting, by the processor of the payment device, a payment method based at least in part on the presence of the occupant in the vehicle, and transmitting, by the processor of the payment device, payment information relating to the payment method to the merchant payment terminal.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a diagram of a payment system shown according to an example embodiment.

FIG. 2 is a flow diagram of a method of manually overriding or sharing a payment method in a vehicle shown according to an example embodiment.

FIG. 3 is a flow diagram of a method of automatic detection of possible new payment sources for overriding or sharing payment methods in a vehicle shown according to an example embodiment.

FIG. 4 is a flow diagram of a method illustrating configuring multiple payment sources for different expenses according to an example embodiment.

FIG. 5 is a flow diagram of a method for automatic adjustment of hardware settings due to the failure of connections during a payment process shown according to an example embodiment.

FIG. 6 illustrates a parking lot use case according to an example embodiment.

FIG. 7 illustrates a top view of the capturing and processing of a financial transaction of a vehicle in motion through an NFC field or other short range communication field according to an example embodiment.

FIG. 8 illustrates a side view of the capturing and processing of a financial transaction of a vehicle in motion through an NFC field or other short range communication field according to an example embodiment.

FIG. 9 illustrates a use case consisting of an interaction between a vehicle and gas merchant in an example embodiment.

FIG. 10 is a flow diagram of a method for a decision making process when a VPD determines its current location and detects an NFC grid or other secure field according to an example embodiment.

### DETAILED DESCRIPTION

Referring generally to the figures, a vehicle payment device (VPD) is described. The VPD facilitates customer payments to a merchant via a merchant terminal from a vehicle associated with the customer. The VPD is integrated in the vehicle or is a separate device positioned in or on the vehicle. The VPD communicates payment information with the merchant terminal to effect the payment. The payment information is communicated wirelessly from the VPD to the merchant terminal (e.g., via NFC, RFID, Bluetooth, Wi-Fi, cellular, etc.). In some arrangements, the VPD stores financial information associated with a default driver of the vehicle, which allows for payment of goods or services received from the merchant. The default financial information can be temporarily overridden or changed when a new occupant uses the vehicle. The temporary financial information is then used for the payment of goods or services related to the actual occupants of the vehicle instead of the default occupant. In an alternative arrangement, the financial information is stored on a financial information computing system instead of on the VPD. In some arrangements, the VPD permits the combining of financial information associated with multiple occupants to allow the sharing of costs for payment of goods or services. The VPD may automatically detect the presence of new occupants and automatically identify new payment sources.

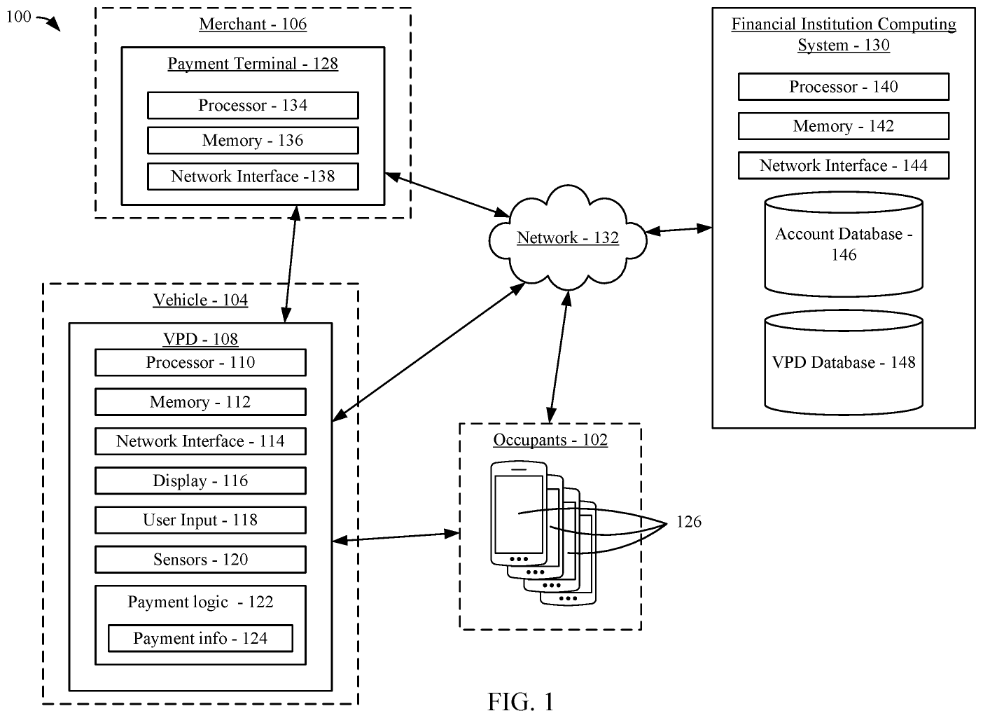

Referring to FIG. 1, a diagram of a payment system 100 is shown according to an example embodiment. As described in further detail below, the payment system 100 facilitates payments for purchases of occupants 102 of a vehicle 104 from a merchant 106. The payment system 100 includes a VPD 108. The VPD 108 is positioned in or on the vehicle 104. For example, the VPD 108 may be an electronic device secured to a dashboard or window of the vehicle 104. In other arrangements, the VPD 108 is integrated into the vehicle 104. In such arrangements, the VPD 108 may be integrated into the infotainment system (e.g., navigation system, media playing system, etc.) of the vehicle 108. As described in further detail below, the VPD 108 serves as a payment device for the occupants 102 of the vehicle 104.

The VPD 108 includes a processor 110 and memory 112. The memory 112 stores programming modules that, when executed by the processor 110, control the operation of the VPD 108. In certain arrangements, the processor 110 and the memory 112 are also associated with the infotainment system of the vehicle 104. The VPD 108 includes a network interface 114. As described in further detail below, the network interface 114 allows the VPD 108 to send and receive data to and from various devices, such as mobile devices 126 associated with the occupants 102, a merchant payment terminal 128 associated with the merchant 106, and a financial institution computing system 130 via a network 132. In some arrangements, the network interface 114 includes the hardware and logic necessary to communicate over multiple channels of data communication. For example, the network interface 114 may include a cellular modem, a Bluetooth transceiver, a Bluetooth beacon, an RFID transceiver, and an NFC transmitter. Data passing through the network interface 114 may be encrypted such that the network interface 114 is a secure communication module. The VPD 108 includes a display 116 and a user input 118. In some arrangements, the display 116 and the user input 118 are combined in the form of a touchscreen device. The display 116 and the user input 118 may also function as the display and user inputs of the infotainment system. The VPD 108 further includes sensors 120. The sensors 120 may include any of location sensors (e.g., GPS, GLONASS, wireless location services, etc.) and vehicle occupancy sensors (e.g., cameras, motion detectors, seat pressure sensors, wireless receivers, etc.). The sensors 120 may include other sensors including accelerometers, gyroscopic sensors, and various biometric sensors.

The VPD 108 facilitates payment to the merchant 106 based on default payment settings, based on the specific occupants 102 in the vehicle 104, or based on a combination thereof. Accordingly, the VPD 108 includes payment logic 122. The payment logic 122 is programmed or built into the VPD 108 and allows for the storage, selection, and transmission of payment information 124. The payment information 124 includes user identification information (e.g., user login information, identification tokens, etc.) and payment sources associated with users identified by the user identification information. The payment sources include any of credit card information, debit card information, bank account information, mobile wallet information, or the like. In some arrangements, the payment logic 122 is programmed with a default payment source. For example, the payment logic 122 can be programmed with payment information relating to the owner of the vehicle 104. The owner's payment information may be used as a default payment source for purchases made from the merchant 106. The merchant 106 may be a traditional retailer, such as a restaurant, a gas station, or another store, or a non-traditional retailer, such as a toll-road operator (e.g., that collects payments for tolls). The payment logic 122 allows for alternate payment sources to override the default payment source. For example, as described in further detail below, the payment logic may be programmed with alternate payment sources relating to various occupants 102 that are actually in the vehicle 104. The payment logic 122 may further allow for the sharing of costs amongst multiple payment sources (e.g., one payment source for each occupant 102), including the default payment method. The payment logic 122 can be programmed with multiple payment sources for different types of expenses (e.g., a first payment source for fuel, a second payment source for tolls, etc.). The payment logic 122 can select different payment sources based on location information received from the sensors 120. For example, a specific payment method may be programmed to be valid only in specific locations (e.g., inside of Seattle). The payment logic 122 can be programmed such that a payment source expires after a set duration (e.g., after two hours). The payment logic 122 can also detect when an alternate payment source entering the vehicle 104 and prompt the occupants 102 for override instructions. These and other use cases are described in further detail below.

The payment system 100 includes a merchant payment terminal 128 associated with the merchant 106. The merchant payment terminal 128 includes a processor 134, a memory 136, and a network interface 138. The memory 136 stores programming modules that, when executed by the processor 134, control the operation of the payment terminal 128. In some arrangements, the network interface 138 includes the hardware and logic necessary to communicate over multiple channels of data communication. For example, the network interface 138 may include a cellular modem, a Bluetooth transceiver, a Bluetooth beacon, an RFID transceiver, and an NFC transmitter. Data passing through the network interface 114 may be encrypted such that the network interface 114 is a secure communication module. The data passing through network interface 114 may be financial payment information which is then communicated through the network 132 to a financial institution computing system 130 to facilitate payment for goods or services.

Still referring to FIG. 1, the payment system 100 includes a financial institution computing system 130. The financial institution computing system 130 includes a processor 140, a memory 142, a network interface 144, an account database 146, and a VPD database 148. The memory 142 stores programming modules that, when executed by the processor 140, control some operations of the financial institution computing system 130. Data passing through the network interface 144 may be encrypted such that the network interface 114 is a secure communication module. The financial institution computing system may communicate to the payment terminal 128 of the merchant 106 in order to approve payment for financial transactions. The account database 146 may store information relating to a plurality of financial account maintained by the financial institution. The VPD database 148 may store one-time use or temporary numbers used in financial transactions. These may be in the form of virtual accounts. One or both of the account database 146 and the VPD database 148 may store and link the serial numbers associated with a VPD 108 to accounts or virtual accounts stored in the databases.

Data communication between the VPD 108, the occupants 102, the payment terminal 128, and the financial institution computing system 130 may be facilitated by the network 132. The network 132 may include the internet.

Still referring to FIG. 1, the occupants 102 of the vehicle 104 may each have their own personal occupant devices 126. The occupant devices 126 may be, for example, smartphones, wearables, implants, tablet computers, PDAs, personal media players, or the like. Accordingly, the occupant devices 126 have the necessary hardware and software to communicate data to the VPD 108 and over the network 132. The occupant devices 126 may communicate to the VPD 108 in various ways known in the art, including via NFC, Bluetooth, Wi-Fi, or the like. The occupant devices 126 may store or have access to financial information relating to the occupants 102. For example, the occupant devices 126 may be used by the occupants to access financial information relating to accounts held with a financial institution by accessing the financial institution computing system 130 via mobile wallets or websites. Each occupant device 126 may emit wireless signals at different frequencies or containing unique device identifiers such that each occupant device can be identified by the VPD 108 and determined to be in or near the vehicle 104.

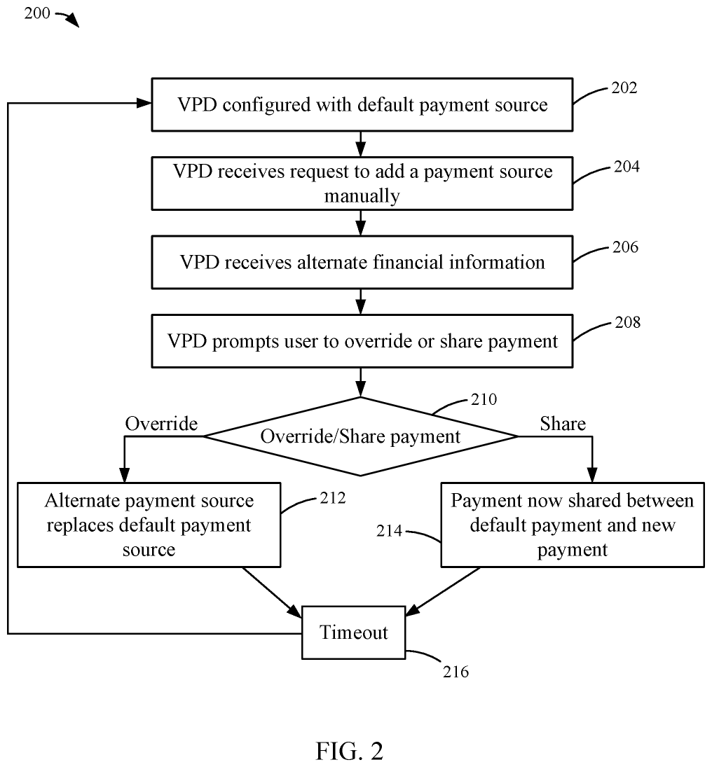

The operation of the VPD 108 within the payment system 100 is described in further detail below with respect to FIG. 2 through FIG. 10.

Referring now to FIG. 2, a flow diagram of a method 200 of receiving an alternate payment source to manually override or share payment with a default payment source of the VPD 108 vehicle is shown according to an example embodiment. The default payment Method 200 is performed by the processor 110 and payment logic 122 that is part of the VPD 108. Method 200 begins with the VPD 108 already being configured with a default payment source at 202. For example, the default payment source may relate to a payment source associated with the owner of the vehicle, the primary driver of the vehicle, or a business associated with the vehicle. The default payment source may relate to a credit card, a debit card, bank account information, or the like. The VPD 108 receives a request to manually add an alternate payment source at 204. The request comes from an occupant of the vehicle. For example, the occupant may be a passenger in the vehicle or an alternate driver of the vehicle, and the occupant would like to pay for (or share in the cost of) expenses occurred while in the vehicle. Accordingly, in response to the request, the VPD 108 prompts the user for the alternate financial information (e.g., via the display 116 of the VPD 108, via the occupant device 126 associated with the requestor, etc.) for the financial information and alternate payment information is received at 206. The alternate payment information is received at the VPD 108 from the occupant providing the alternate payment information. The alternate payment information is different than the default payment source. As described briefly above, the alternate payment information may be entered in the event that the vehicle is borrowed or rented. In some arrangements, the alternate payment information can be used in conjunction with the default payment source to share future costs and payments with the default payment source. In other arrangements, the alternate payment information can be used instead of the default payment source. The alternate payment information is provided manually by an occupant of the vehicle. In some arrangements, the alternate payment information may be entered into the VPD 108 through a touchscreen interface (e.g., display 116) or from a user's device (e.g., occupant device 126). In other arrangements, other methods of receiving the alternate payment information may be used, such as a credit card reader, communication with a mobile wallet, etc. In some situations, sensors and accessories attached to the VPD 108 or to a user's device facilitate the provision of the alternate financial information (e.g., a credit card magnetic stripe reader attached to the occupant device 126, smart chip reader of the VPD 108, etc.).

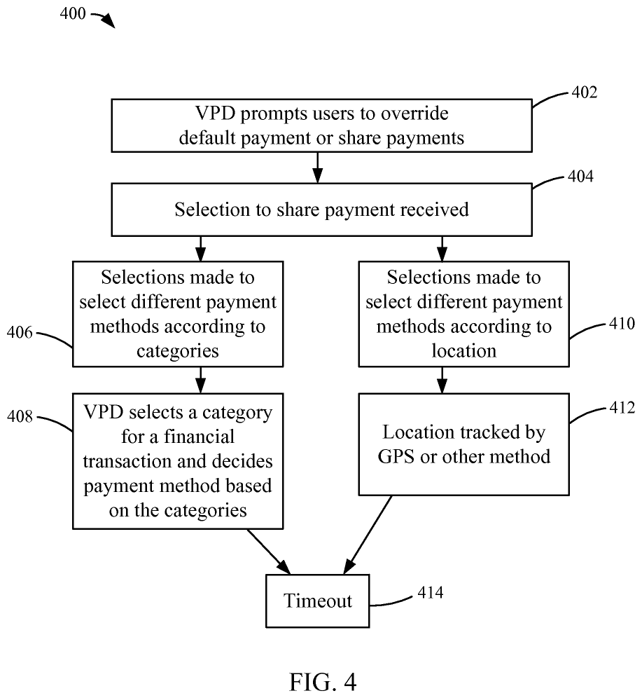

Continuing with method 200, after the alternate financial information is received at 206, the VPD 108 prompts the user whether the alternate payment information will override or share payment with the default payment source at 208. In response to the prompt, the user can indicate to the VPD 108 whether the alternate payment information will override (i.e., replace) or share payment with the default payment source. At 210, the VPD 108 determines whether the alternate payment information will override the default payment source or share payment with the default payment source. If the override option is received, the alternate payment source replaces the default payment source at 212. In some situations, the alternate payment source temporarily replaces the default payment source. If the share option is received, the default payment source will share future costs with the alternate payment source at 214. Some examples of share options are shown in method 400 illustrated in FIG. 4. In such situations, the users or occupants of the vehicle may specify the percentage split between the default payment source and the alternate payment source. The VPD 108 may automatically default to an even split between the payment sources in the event no percentage split information is provided by the occupants.

As noted above, the alternate payment source is generally a temporary payment source programmed into the VPD 108. Accordingly, the alternate payment source timeouts at 216. When the alternate payment source timeouts (i.e., expires), the default payment source is restored by the VPD 108. This timeout may be a preset amount of time or a user configurable amount of time selected at the time the alternate payment source is received (e.g., selected at 206). Alternatively, the timeout may also be linked to a driving session where the vehicle 104 has been turned off or to a driving session where the amount of time the vehicle 104 has been turned off has exceeded a certain time threshold. Still further, the timeout may also be linked to a trip, business or otherwise, and the timing may be obtained from an electronic calendar. Still further, the timeout may be linked to a one time use of a vehicle 104 for a trip (e.g., in a taxi, driverless or otherwise) In a further arrangement, the timeout is associated with a user provided indication received by the VPD 108 indicating the cancelation of the alternate payment source.

In situations in which the alternate payment source is used to share costs with the default payment source, method 200 may be repeated two or more times to share payment across two or more alternate payment sources in addition to the default payment source. Shared payment may also be accomplished with two or more alternate payment sources without including the default payment source.

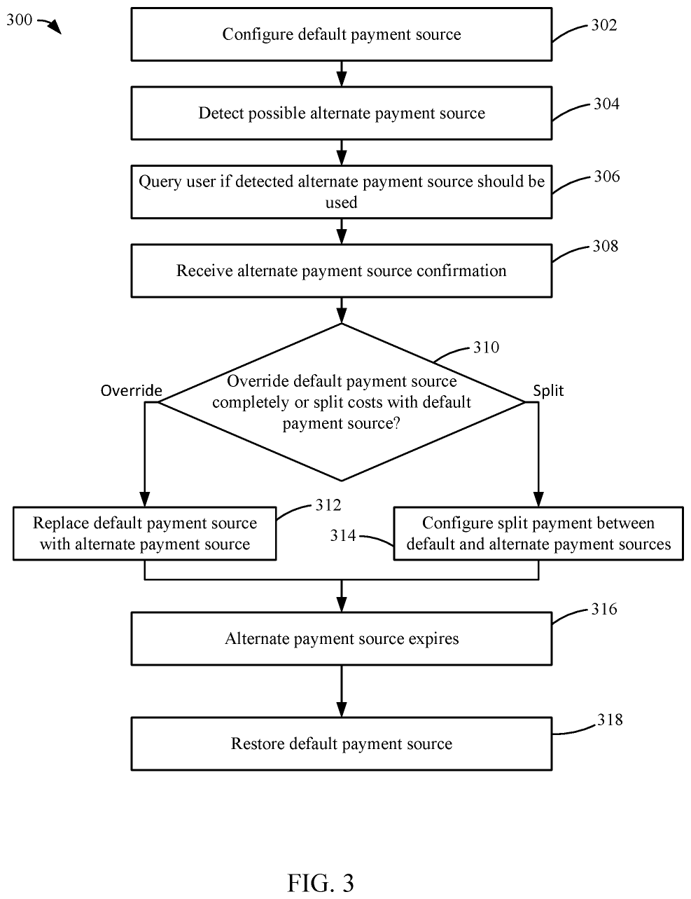

Referring now to FIG. 3, a flow diagram of a method 300 of automatic detection of possible new payment sources for overriding or sharing payment methods in a vehicle is shown according to an example embodiment. Method 300 is performed by the processor 110 and payment logic 122 that is part of the VPD 108. Method 300 begins with the VPD 108 already configured with a default payment source 302. The VPD detects the presence of possible alternate payment sources at 304 (e.g., an individual's mobile wallet on a mobile device). The VPD 108 queries the user(s) whether the detected alternate payment source should be used at 306 and receives confirmation to use the alternate payment source at 308. The user can answer yes or no to the query. If the user answers no, method 300 ends. For the sake of continuing the description of method 300, it is assumed that the user answers yes at 306.

If the alternate payment source is used, the VPD 108 establishes a secure connection with the source of the payment technology. The secure connection may be through NFC, Bluetooth, secure Wi-Fi, etc. The VPD 108 then receives information for the alternate payment source. The VPD 108 through the mobile device may then prompt the user(s) to override the default payment method contained in the VPD or share the cost of future payments at 310. In an alternate embodiment of the method the device prompting the user(s) may be the VPD itself or individualized control screens located near individual seats. The individualized control screens may be installed in the vehicle or portable. The default payment information may be overridden in the event that the vehicle is borrowed or rented. Future payments may be shared in the event that the two or more individuals are present in the vehicle.

Continuing with method 300, after the user is prompted at 306, a user selection may be received whether the alternate payment source information will override the default payment source or share payment with the default payment source at 310. The user selection is received by the VPD. The user selection includes an indication of whether the alternate payment source is used to override the default payment source or share in the expenses with the default payment source. If the override option is chosen, the default payment source will be temporarily replaced with the alternate payment source at 312. If the share option is chosen, the default payment source will share future costs with the alternate payment source at 314. Some examples of share options are shown in method 400 illustrated in FIG. 4. If the override or shared payment option is taken, this will generally be a temporary change and the alternate payment source will timeout at 316. In such situations, the default payment source will again be in force in the VPD at 318. The above-described temporary use of the alternate payment source may be for a preset amount of time or for a user-configurable amount of time selected at the time the alternate payment source is entered. The alternate payment source may also be set to last indefinitely until there is a cancelation of the alternate payment source by a user. In situations in which the alternate payment source is applied in conjunction with the default payment source to share payments, method 300 may be implemented two or more times to share payment with two or more alternate payment sources in addition to the default payment source. Sharing payment may also be done with two or more alternate payment sources without including the default payment source. In such situations, the users or occupants of the vehicle may specify the percentage split between the default payment source and the alternate payment source(s). The VPD 108 may automatically default to an even split between the payment sources in the event no percentage split information is provided by the occupants.

Referring now to FIG. 4, a flow diagram of a method 400 of configuring multiple payment sources for different expenses. Method 400 describes two different examples of sharing the payment, which may be applied in method 300 of FIG. 3 (e.g., at 314) or in method 200 of FIG. 2 (e.g., at 214). Method 400 is performed by the processor 110 and payment logic 122 that is part of the VPD 108. Method 400 begins with prompting the users to override the default payment source of the VPD or to share future payments at 402. The device prompting the user may be the VPD or a personal device (e.g., occupant device 126) in communication with the VPD and available to the user. The VPD receives the selected option to share payments at 404. The VPD may receive the option to share payments after receiving manual entry of an alternate payment source or after the VPD automatically detects an alternate payment source with authorization to use.

Continuing the method 400, various sharing options may be presented to the user(s) to share future payments in the vehicle. One possible sharing option presented may be to select different payment methods for expenses involving the vehicle according to categories at 406. Categories may include toll-way expenses, fuel expenses, drive-thru expenses, etc. When there is a cost incurred, the VPD selects a category for the financial transaction and decides the payment method based on the category at 408. The category may be selected by accessing a database, prompting the user(s), historical usage, and the like.

Another possible sharing option may be to select different payment methods for expenses according to the current location of the vehicle at 410. For example, a user selection may be received to set a payment method to be used when within the city of Seattle. The location of the vehicle may be tracked by GPS or another location tracking system at 412. For example, the location of the vehicle may be determined using the location services of the VPD. In some arrangements, the shared payments arrangement is a temporary change to the default payment source. In such arrangements, the alternate payment source and shared payments configuration timeouts or expires at 414. After expiration, the VPD restores the default payment source. The timeout may be based on a preset amount of time or a user-configurable amount of time received at the time the alternate payment source is received. The timeout may also be set to last indefinitely (e.g., until a cancelation of the alternate payment source is received). Alternatively, the timeout can be linked to a driving session where the vehicle 104 has not been turned off or linked to a driving session where the amount of time the vehicle 104 has been turned off has exceeded a certain time threshold. Still further, the timeout may be linked to a trip, business or otherwise, and the timing may be obtained from an electronic calendar associated with the user of the vehicle 104. In a further arrangement, the timeout is associated with a user provided indication received by the VPD 108 indicating the cancelation of the alternate payment source. For sharing payment, multiple additional alternate payment methods may be present in addition to any default payment source.

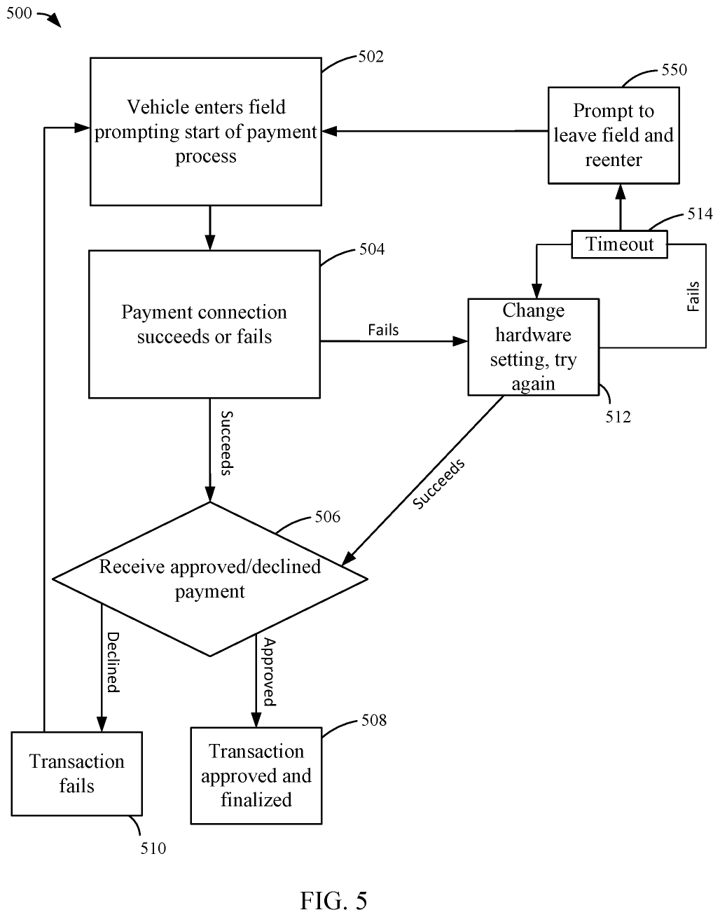

Referring to FIG. 5, a flow diagram of a method 500 for automatic adjustment of hardware settings due to the failure of connections during a payment process is shown according to an example embodiment. Method 500 is performed by the processor 110, network interface 114, and payment logic 122 that is part of the VPD 108. The vehicle may enter into a merchant field prompting the start of a payment process 502. The vehicle is equipped with a VPD (e.g., VPD 108). The merchant field may be a NFC field or other secure, short-range communication field. The payment connection may then either succeed or fail at 504. If the payment connection succeeds, the VPD may prompt the driver of the vehicle or other occupant to approve the transaction and receive information regarding approval or declining payment at 506. If the transaction is approved by the user, the VPD transmits payment data to the merchant, the transaction is finalized, and the payment is charged to the payment source at 508. If the user declines the payment, payment data is not sent from the VPD to the merchant, the transaction is not finalized, and the transaction fails at 510. After the failed transaction at 510, the VPD returns to a standby state until the vehicle enters a new merchant field. Alternatively, the payment process may fail due to an error in communication between the VPD and the merchant at 506. For example, the wireless connection between the VPD and the merchant payment field may drop mid transaction. In such situations, the VPD may attempt to change one or more of its hardware settings and reattempt the transaction at 512. The VPD can continue to change different hardware settings until it succeeds and can then receive information that the payment has been approved or declined at 506. At a certain point, there may be a timeout at 514 to stop hardware changing attempts and have the VPD prompt the vehicle or user to leave the field and reenter at 550. Hardware settings that may be changed or reconfigured may include transmit power control settings, using a new phase offset setting, use of a new wakeup threshold setting, use of a new signal damping coefficient setting, use of a new frame delay setting, etc.

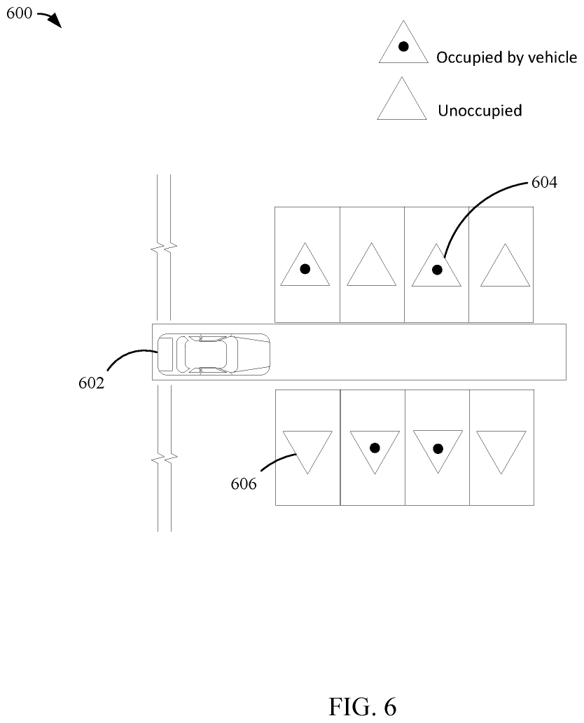

Referring to FIG. 6, a parking lot use case 600 for the VPD 108 is illustrated according to an example embodiment. As represented by the triangles of FIG. 6, each space may contain a secure communication device to communicate payment. The secure communication device located in each space may be part of a parking lot system configured to work with vehicles that contain a VPD. The vehicle 602 may link and authenticate with the secure communication devices. The vehicle 602 is equipped with a VPD (e.g., VPD 108). Each space is monitored to sense whether the space is an occupied spot 604 or an unoccupied spot 606. An occupied spot 604 may be determined by the parking system or the VPD based on feedback from another VPD associated with a vehicle in the occupied spot 604. Alternatively, if the vehicle in the occupied spot 604 does not have a VPD, the parking system can determine that there is a vehicle in the occupied spot 604 based on sensors, such as proximity sensors, weight sensors, inductive sensors, etc. Such information may be collected and display on a map or sent directly to the vehicle 602 and shown on the display of a VPD or the display of a mobile device to locate empty parking spaces.

Still referring to FIG. 6, the parking system also facilitates automatic payment from vehicles having a VPD that are parked in a given parking space. The parking system may charge a flat fee for use of an empty parking spot 606 or a variable parking fee based on duration of use. Duration of use of the parking spot may be determined by the parking system or VPD timing when the vehicle enters the field of the secure communication device for that spot and then subsequently when the vehicle leaves the field. In such situations, the time charged is equal to the difference between the two times. Payment is automatically facilitated from the VPD to the parking system via the VPD. The VPD may pay, for example, with a default payment source or an alternate payment source in any manner described above in the VPD.

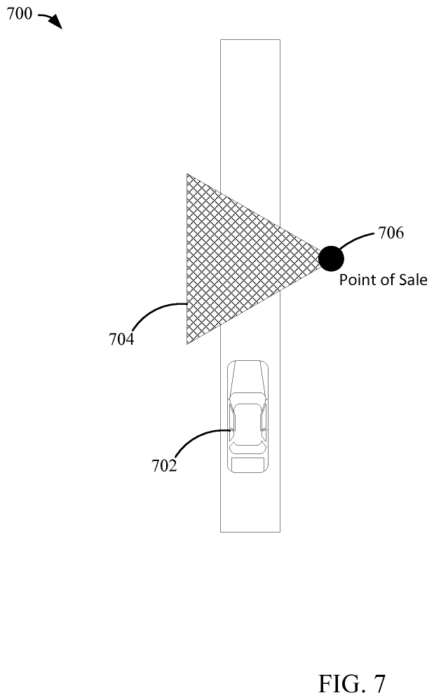

Referring to FIG. 7, a top view of the capturing and processing of a financial transaction 700 of a vehicle 702 in motion through an NFC field 704 or other short range communication field is illustrated according to an example embodiment. The vehicle 702 is equipped with a VPD (e.g., VPD 108). The VPD may be configured to automatically accept a financial transaction from the particular merchant of the secure transaction device 706. The secure transaction device 706 may be a NFC device, secure Wi-Fi, etc. The VPD may be configured to alert the user if the financial transaction failed due to insufficient time to complete or other factors. The VPD may alert the user with other information including whether the financial transaction succeeded, the monetary amount of the transaction, etc. The VPD may be configured to alert the user through a personal device of the user if the financial transaction failed or other relevant information. Another attempt with a hardware setting change may be required for successful payment as illustrated in FIG. 5. Payment may be automatic by use of the default or current payment method in the VPD. Payment may also be by any alternate source of payment present in the VPD.

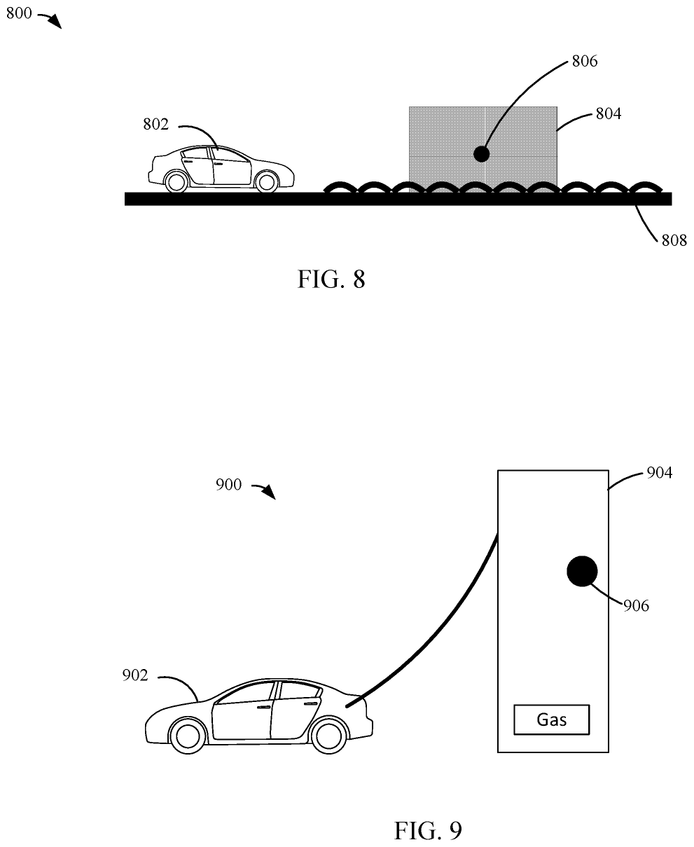

Referring to FIG. 8, a side view of the capturing and processing of a financial transaction 800 of a vehicle 802 in motion through a NFC field 804 or other short range communication field is illustrated according to an example embodiment. The vehicle 802 is equipped with a VPD (e.g., VPD 108). The VPD may be configured to automatically accept a financial transaction from the particular merchant of the secure transaction device 806. The secure transaction device 806 may be a NFC device, secure Wi-Fi, etc. The VPD may be configured to alert the user if the financial transaction failed due to insufficient time to complete or other factors. The VPD may alert the user with other information including whether the financial transaction succeeded, the monetary amount of the transaction, etc. There may be speed reducing strips 808 on the road to help allow for enough time to complete the transaction. The VPD may be configured to alert a user through a personal device of the user if the financial transaction has failed or other relevant information. Another attempt with a hardware setting change may be required for successful payment as illustrated in FIG. 5. Payment may be automatic by use of the default or current payment method in the VPD. Payment may also be by any alternate source of payment present in the VPD.

Referring to FIG. 9, an example embodiment of a use case 900 consisting of an interaction between a vehicle and gas merchant is illustrated. The vehicle 902 has an installed VPD that is used to interface with a merchant. An example of a merchant is a gas station terminal 904 with a secure transaction device 906. The VPD in the vehicle 902 may detect or activate the NFC field, secure Wi-Fi, etc., and recognize the presence of a secure transaction device 906, whereupon the handshaking takes place to enable a communication channel to complete a financial transaction. The VPD in the vehicle 902 may allow for sending data over the interface to the secure transaction device 906 allowing for the input of a desired amount of gasoline, enable the transaction and send instructions to the secure transaction device 906 to limit the transaction for the vehicle to be filled to the inputted amount of gasoline.

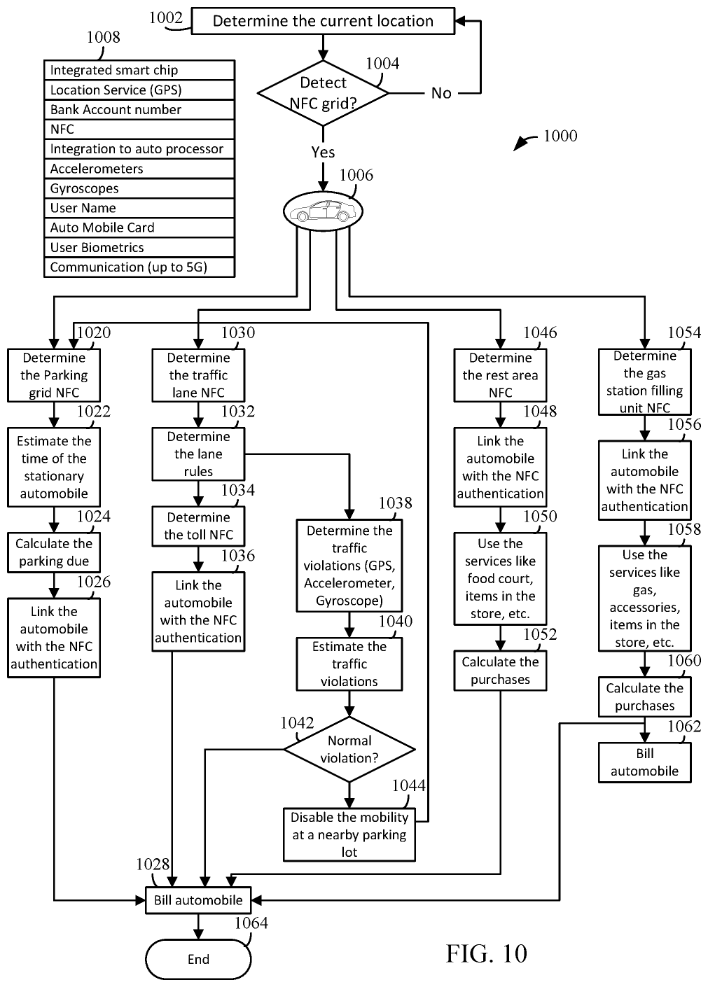

Referring to FIG. 10, a flow diagram of a method for a decision making process 1000 when a VPD determines the current location 1002 and detects an NFC grid or other secure field 1004 is shown according to an example embodiment. The vehicle 1006 may include a VPD (e.g., VPD 108) that has a list of features such as an integrated smart chip, location service module (such as GPS), an integrated payment method (such an a bank account number, user name, credit card information, etc.), a near field communication module, integration to a processor, sensors including accelerometers, gyroscopes, and various biometrics, communication module (including cellular networks up to and including 5g).

The NFC field or other secure field detected may be a gas station filling unit near field communication device 1054, where the vehicle VPD and gas station filling unit are linked through authentication 1056. The driver of the vehicle and any passengers may then use such services or make purchases such as gas, accessories, store items etc., 1058, whereupon the purchases are calculated 1060 and the financial transaction finished by using the payment method in the VPD 1062 and the process ended 1064.

The NFC field or other secure field detected may be at a rest area 1046, where the vehicle VPD and rest area secure communication unit are linked through authentication 1048. The driver of the vehicle and any passengers may then use such services as food at a food court, store items etc., 1050, whereupon the purchases are calculated 1052 and the financial transaction finished by using the payment method in the VPD 1028 and the process ended 1064.

Continuing with FIG. 10, the NFC field or beacon detected may be in a traffic lane on a roadway for toll charges. The VPD may determine the presence of a traffic lane secure communication unit using NFC or beacon technology at 1030. The lane rules governing the toll charges may be determined at 1032. The toll lane NFC field or other secure field may be detected and determined at 1034. The VPD and the secure communication unit associated with the toll lane's NFC field or other secure field are linked through authentication at 1036. The financial transaction finished by using the payment method in the VPD at 1028 and the process ended at 1064.

Further, traffic violations may be determined by the VPD (possibly through the use of GPS, accelerometer sensors, gyroscopic sensors, etc.) at 1038. The estimated amount of fines for the traffic violations may be determined at 1040. If the violation is normal, then the vehicle finishes the financial transaction by using the payment method in the VPD at 1028. If not a normal violation, the vehicle may be disabled in a nearby parking lot at 1044 where a parking grid charge may apply. The steps for use of the parking lot may include determining the parking grid NFC or other secure field at 1020, estimating the time the vehicle remains stationary at 1022, calculating the parking amount due at 1024, linking the vehicle using the NFC or other secure field communication at 1026, and paying the bill using the financial payment source at 1028.

Returning to FIG. 1, in one arrangement, the vehicle 104 may approach the secure network interface 138 of a gas station pump. The vehicle 104 is equipped with a VPD (e.g., VPD 108). The VPD 108 of the vehicle 104 may link and authenticate with the secure network interface 138 using the VPD network interface 114. The driver or a passenger of the vehicle 104 can then use the services available such as to pump gas, pump air, purchase items in the adjacent convenience store, etc. if the payment information 124 is present. The purchases may be calculated and then the VPD 108 receives the final transaction amount and the bill settled through the payment logic 122 linked to the VPD 108. In another arrangement, the location may be a rest area with various facilities and services available instead of a gas station.

In another arrangement of a method using the payment system 100 of FIG. 1, the vehicle 104 may approach the network interface 138 positioned to secure payment for a pay parking lot. The vehicle 702 is equipped with a VPD (e.g., VPD 108). Alternatively each parking spot in a pay parking lot could be the location of a network interface 138. The VPD 108 of the vehicle may link and authenticate with the network interface 138. The driver of the vehicle 104 may then pay the fee to use the pay parking lot or pay parking spot if they are set up as the default payment. This may be a flat fee or one based on duration of use. Duration of use of the parking spot may be dictated by the vehicle 104 entering the field of the merchant 106 network interface 138 and then subsequently leaving the field with the duration based on the difference.

In another arrangement of a method using the payment system 100 of FIG. 1, the vehicle 104 may approach the network interface 138 positioned to secure payment for a toll plaza. The vehicle 702 is equipped with a VPD (e.g., VPD 108). The VPD 108 of the vehicle 104 network interface 114 may link and authenticate with the merchant 106 network interface 138. The driver of the vehicle 104 can then pay the fee to use the toll plaza if they are set up as the default payment. The VPD 108 may be configured to finish the transaction in an amount of time to compensate for motion of the vehicle 104. In one specific implementation of the arrangement, the tollbooth and VPD 108 may negotiate over a secure communication channel, authenticate each other, create a secure package with payment and additional information, deliver the package, get an ack (i.e., an acknowledgment), close the transaction securely, and update the occupants 102 electronic wallet containing financial information inside the vehicle.

In another arrangement of a method using the payment system 100 of FIG. 1, the VPD 108 may include a method of aligning a vehicle 104 enclosure with the vehicle 104 detecting by a location sensor 120 the location of the VPD 108, determining by a gyroscopic sensor 120, the orientation of the VPD 108, estimating by a processor 110 an alignment area of the VPD 108, and selectively changing the orientation of the VPD 108 by moving the vehicle or suggesting a direction of motion. The motion location sensor 120, gyroscopic sensor 120 and processor 110 may create an alert of non-alignment and the vehicle 104 may be moved in response to detecting a merchant field of a merchant terminal. The vehicle 104 enclosure may be displayed and alerted on the display 116 during the non-alignment alert by beeping and being highlighted in a red color. The highlighted color may turn to green when there is successful alignment.

In another arrangement of a method using the payment system 100 of FIG. 1, the VPD 108 along with its network interface 114 and the Financial Institution Computing System 130, along with its network interface 144 is used. A temporary credit card number may be created (also known as virtual or disposable numbers), securely communicated between the Financial Institution Computing System 130 and the VPD 108 using network interface 114 and network interface 144. This temporary credit card number may then be used with the merchant 106. In this manner, costs can be shared in different ways between occupants 102 and the default payment with only one transaction needed at the merchant payment terminal 128.

In another arrangement of a method of using the payment system 100 of FIG. 1, the VPD 108 is used to temporarily override the stored default financial information. This request to temporarily override may be input through a display 116 with touchscreen capability or through other user input 118 methods to the VPD 108. The request to override may be made to be temporary providing temporary overriding of payment information 124. The financial information transmitted to the merchant 106 payment terminal 128 is then the temporary financial information. The detection of alternate financial information may be automatic by the VPD 108 where the VPD 108 detects the presence of an additional source of financial information (e.g. a smart phone with a mobile wallet capable of communicating with Bluetooth). The VPD 108 may then establish a secure communications channel between the alternate source of financial information and after receiving permission, override the default payment with the alternate financial information or combine the two or more sources of financial information to share costs. The overriding financial payment method or any combination may then be used to provide payment for goods or services.

In another arrangement of a method using the payment system 100 of FIG. 1, the VPD 108 may limit the use of the default payment information or combination of default payment information and alternate information based on receiving restriction information. The restriction information may limit the use of the alternate payment information in various ways such as limiting it to specific types of costs, to specific locations, or for a set duration of time.

In another arrangement of a method using the payment system 100 of FIG. 1, the VPD 108 may use sensors such as biometric sensors 120 to obtain approval or permission to use the alternate financial information. Biometric sensors 120 could be used either for approval of manual entry of alternate financial information or approval of any such alternate financial information detected automatically. Sensors 120, such as biometric sensors could also be used for final approval after a potential financial transaction has taken place.

In another arrangement of a method using the payment system 100 of FIG. 1, there is an ability to override the default payment method associated with a VPD 108. The system and method would allow an individual who is borrowing the vehicle to use the payment system connected with a vehicle 104. Alternatively, multiple users may each provide a payment method that would enable them to share costs that are paid using the VPD 108. One of the multiple users may include the owner or driver of the vehicle who may be connected to the default payment method.

In another arrangement of a method using the payment system 100 of FIG. 1, there may be the ability of a VPD 108 that is capable of detecting NFC modules or other wireless modules to assist a driverless vehicle that may use such modules placed on the surface of roads, buildings or other structures. The vehicle 104 may use these NFC modules along with the VPD 108 to position itself. Additional active sensors (e.g., laser tracking, radar tracking, ultrasonic distance measurement, etc.) or passive sensors (e.g., cameras, GPS, etc.) may work in conjunction with the detection of NFC modules to stay properly positioned and oriented and to avoid collisions. The NFC modules may provide guidance with simply their presence because they are laid out in a known pattern that can be followed. Additional information can be provided by the NFC module to the driverless vehicle such as the position of the module. This may be in the form of GPS coordinates. Other information that could be provided by the NFC modules to the VPD 108 is a general direction of travel. This could be obtained if the NFC modules are capable of communicating to each other, by a wired or wireless network, such that each NFC module would be aware of which modules have been in communication with the driverless vehicle. The vehicle 104 may have a default payment method that can be overridden by a user present in the driverless vehicle to allow payment for various costs associated with using the driverless vehicle (toll roads, parking lots, etc.) Payment may be automatic by use of the default or current payment method in the VPD 108. Payment may also be by any alternate source of payment present in the VPD 108. Timeout to return to the default payment method or to return to the absence of a payment method may occur when the trip using the driverless vehicle has ended and the user has exited the vehicle 104.

In another arrangement of a method using the payment system 100 of FIG. 1, there is a VPD 108 and a merchant 106 payment terminal 128 with a network interface 138. The VPD 108 may include a processor 110, a network interface 114 in communication with the processor 110, and payment logic 122 in communication with the processor 110. In response to detecting that a payment transaction has failed at the merchant 106 payment terminal, the VPD 108 may be reconfigured using at least one new hardware control setting before attempting another payment transaction at the merchant terminal. As non-limiting examples, the VPD 108 may be reconfigured to perform a subsequent payment using a new transmit power control setting, using a new phase offset setting, using a new wakeup threshold setting (e.g., a setting that determines the maximum distance that the VPD 108 needs to be held from the merchant payment terminal 128 in order for the VPD 108 to initiate the payment transaction), using a new signal damping coefficient setting, using a new frame delay setting (e.g., a setting that sets forth a period of time that the VPD 108 needs to wait before sending an acknowledgement in response to receiving a request from the merchant payment terminal 128), etc. If desired, other types of hardware updates may be implemented.

In another arrangement of a method of using the payment system 100 of FIG. 1, a VPD 108 payment transaction may be initiated by placing the vehicle 104 within a field that is generated by the merchant terminal (NFC grid, etc.). For a variety of reasons, it is possible for a VPD 108 transaction to fail at the merchant payment terminal 128. The vehicle 104 may have to physically move out of the field and back within the field to reattempt the transaction with the new hardware settings. There may be a timer that starts from when the field is recognized from before.

In another arrangement of a method using the payment system 100 of FIG. 1, an ability may be described that would allow for a VPD 108 to make an audio and/or video call to other vehicles 104 equipped with a VPD 108 through a network interface 114. The VPD 108 may utilize quad band communication technology for this function. Payment for the service may be accomplished through the payment method linked to the VPD 108 whether it is the default payment method, overridden payment method, or shared payment method.

Various embodiments and descriptions using a vehicle are used for illustrative purposes. It should be noted that the description of the technology is not limited to the use in vehicles and may be extended to other scenarios and situations. For example, the electronic device may be integrated in any mode of transportation. For a further example, the vehicle payment device handling default payment methods and transactions may be fully contained in a cellular phone or other portable electronic device.

The embodiments of the present invention have been described with reference to drawings. The drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An example system for implementing the overall system or portions of the invention might include a general purpose computing computers in the form of computers, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. Input devices, as described herein, include a keyboard, a keypad, a mouse, joystick or other input devices performing a similar function. The output devices, as described herein, include a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention as defined in the appended claims. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangement of the embodiments without departing from the scope of the present invention as expressed in the appended claims.

1. A method of facilitating a payment to a merchant from a customer via a payment device associated with a vehicle, the method comprising:
detecting automatically, by an infotainment system of a vehicle, an indication of a presence of an occupant in the vehicle by receiving a communication from a mobile device of the occupant;
receiving, by the infotainment system, an indication of a presence of a source of second financial information in the vehicle, wherein a first financial information corresponding to the occupant is stored on the infotainment system;
establishing a secure communications channel between the infotainment system and the source of second financial information;
receiving, by the infotainment system, the second financial information for storing on the infotainment system;
receiving, by the infotainment system, a payment request from a merchant payment terminal;
selecting, by the infotainment system, a payment method from among the first financial information and the second financial information based at least in part on default payment settings of the occupant in the vehicle received from the mobile device of the occupant; and
transmitting, by the infotainment system, payment information relating to the payment method to the merchant payment terminal.

2. (canceled)

3. The method of claim 1, wherein the payment financial information is related to financial information of the occupant in the vehicle.

4. The method of claim 1, wherein the communication between the mobile device and the infotainment system takes place using NFC.

5. The method of claim 1, wherein the occupant is a first occupant having a first mobile device, the method further comprising:
detecting automatically, by the infotainment system, an indication of a presence of a second occupant of the vehicle by receiving a communication from a second mobile device of the second occupant;
automatically detecting, by the infotainment system, a new payment source based on data from the second mobile device of the second occupant;
receiving, by the infotainment system from the second mobile device of the second occupant, a request for temporarily overriding from the default payment settings for the first occupant to temporary payment settings for the second occupant.

6. The method of claim 1, further comprising:
receiving, by the infotainment system, authorization to temporarily override the first financial information with the second financial information to use as the payment information.

7. The method of claim 1, further comprising:
receiving, by the infotainment system, authorization to temporarily combine the first financial information and the second financial information, wherein the combination is used as the payment information.

8. The method of claim 7, wherein the combination of first financial information and second financial information is used to create a one-time use virtual credit card number which is used as the payment information

9. The method of claim 7, further comprising:
receiving restriction information; wherein the restriction information is used to limit the use of the combination of the first financial information with the second financial information.

10. The method of claim 6, wherein the receiving authorization step further comprises receiving information from a biometric sensor.

11. The method of claim 7, wherein the receiving authorization step further comprises receiving information from a biometric sensor.

12. A financial institution computing system associated with a financial institution, the system comprising:
a network interface configured to communicate with a vehicle payment device integrated into a vehicle and a merchant point of sale terminal associated with a merchant via at least one network;
an account database storing information relating to a plurality of financial accounts maintained by the financial institution;
a vehicle payment device database storing information relating to identifying vehicle payment devices;
a memory; and
at least one processor configured to:
receive, from a customer device, one or more payment settings corresponding to a selected payment method for at least one of a category of a purchase or a location of the vehicle;
receive, from the vehicle payment device via the at least one network, a transaction request, the transaction request including information related to two or more of the plurality of financial accounts corresponding to occupants of the vehicle;
generate a virtual payment number linked to the two or more of the plurality of financial accounts to combine the two or more financial accounts as a source for a payment request, wherein the virtual payment number corresponds to at least one of the one or more payment settings;
transmit, to the customer device via the at least one network, the virtual payment number;
store the virtual payment number; and
receive, from the merchant point of sale terminal, a payment request including the virtual payment number in response to the payment request satisfying the one or more payment settings.

13. The financial institution computing system of claim 12, wherein the virtual payment number is a virtual credit card number.

14. A vehicle comprising:
an infotainment system comprising:
a network interface configured to communicate with a merchant point of sale terminal associated with a merchant and a financial institution computing system associated with a financial institution;
a memory storing default payment information for a customer;
at least one processor configured to:
receive alternate payment information;
store the alternate payment information in the computer memory;
receive a request for a transaction between the customer and the merchant;
share costs associated with the transaction between the default payment information and the alternate payment information by performing a first financial transaction corresponding to a first portion of the costs using the default payment information, and performing a second financial transaction corresponding to a second portion of the costs using the alternate payment information, wherein the first portion of the costs and the second portion of the costs together equal the cost associated with the transaction; and
communicate data corresponding to the first financial transaction and the second financial transaction over the network interface to the financial institution computing system for completion of the first financial transaction and the second financial transaction; and
a display capable of communicating to a user.

15. The vehicle of claim 14, wherein the processor is further configured to automatically recognize the presence of an alternate source of payment information through the network interface.

16. The vehicle of claim 15, wherein the alternate source of payment information is a mobile wallet.

17. The vehicle of claim 14, wherein the at least one processor is further configured to communicate over the network interface to the financial institution computing system to receive a virtual credit card number to use to pay the costs associated with the merchant.

18. A non-transitory computer-readable media having computer-executable instructions embodied therein that, when executed by a processor of a vehicle payment device, cause the vehicle payment device to perform a process of facilitating a payment to a merchant from a customer via the vehicle payment device associated with a vehicle, the process including:
detecting automatically, by an infotainment system of a vehicle, an indication of a presence of an occupant in the vehicle by receiving a communication from a mobile device of the occupant;
receiving, by the infotainment system, an indication of a presence of a source of second financial information in the vehicle, wherein a first financial information corresponding to the occupant is stored on the infotainment system as a default payment information;
establishing a secure communications channel between the infotainment system and the source of second financial information;
receiving, by the infotainment system, the second financial information for storing on the infotainment system, wherein the second financial information is an alternate payment information;
receive, by the infotainment system, one or more payment settings corresponding to a selected payment method for at least one of a category of a purchase or a location of the vehicle, wherein at least one payment setting comprises a setting for sharing costs between the default payment information and the alternate payment information;
receiving, by the processor of the vehicle payment device, a payment request from a merchant payment terminal;
selecting, by the infotainment system, a payment method based at least in part on the one or more payment settings of the occupant in the vehicle received from the mobile device of the occupant, wherein the selected payment method comprises sharing costs corresponding to the payment request between the default payment information and the alternate payment information according to the at least one payment setting by performing a first financial transaction corresponding to a first portion of the costs using the default payment information, and performing a second financial transaction corresponding to a second portion of the costs using the alternate payment information, wherein the first portion of the costs and the second portion of the costs together equal the cost associated with the transaction; and
transmitting, by the infotainment system, payment information relating to the first financial transaction and the second financial transaction to the merchant payment terminal.

19. (canceled)

20. The non-transitory computer-readable media of claim 18, wherein the payment information is related to financial information of the occupant in the vehicle.

21. The non-transitory computer-readable media of claim 18, wherein the communication takes place using NFC.

22. The non-transitory computer-readable media of claim 18, the process further comprising:
receiving a request for temporarily overriding the default financial information stored in memory of the infotainment system with the alternate financial information.

23-24. (canceled)

25. The non-transitory computer-readable media of claim 18, wherein the combination of the first financial information and the second financial information is used to create a one-time use virtual credit card number which is used as the payment information

26. The non-transitory computer-readable media of claim 24, the process further comprising:
receiving restriction information; wherein the restriction information is used to limit the use of the combination of the first financial information with the second financial information.

27. The non-transitory computer-readable media of claim 18, wherein the receiving authorization step further comprises receiving information from a biometric sensor.
